(19) United States
(12) Patent Application Publication
(10) Pub. No.: US 2004/0117270 A1
(43) Pub. Date: Jun. 17, 2004

(54) Apparatus for and method of creating purchase information for online shopping service

(75) Inventor: Yasuo Sugahara, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/729,897

(22) Filed: Dec. 9, 2003

(30) Foreign Application Priority Data
Dec. 10, 2002 (JP) 2002-358527

(51) Int. Cl. G06F 17/60

(52) U.S. Cl. 705/26; 705/5

(57) ABSTRACT

An apparatus for creating purchase information includes a storage unit, a searching unit, and a creation unit. The storage unit storages purchase information concerning items selected by a customer from an item list provided by an online shopping service. The searching unit searches the storage unit for the purchase information corresponding to a search condition received from a person, e.g., a supervisor who manages the online shopping service, other than the customer. The creation unit creates purchase information concerning an item to be purchased by the person, based on the purchase information searched.

### BACKGROUND OF THE INVENTION

1) Field of the Invention

The present invention relates to an apparatus for and a method of creating purchase information for an online shopping service, and a computer program product that realizes the method.

2) Description of the Related Art

Conventionally, when a customer purchases items on an online shopping Web site that is provided by a server connected to the Internet, the customer utilizes, in many cases, temporary registration information about items to be purchased that is called a shopping cart. The customer registers desired items in the shopping cart to create the shopping cart. The customer finally settles the registered items thereby to efficiently achieve the online shopping.

In this case, the customer operates Web browser software to repeat selection of individual items and registration of the items into the shopping cart until all the desired items are registered into the shopping cart. Particularly, on the online shopping Web site that sells personal computers, in many cases, the customer can select a type of a personal computer as well as select options of parts such as a central processing unit (hereinafter, “CPU”), a memory, a hard disk, etc. thereby to purchase these items.

In the online shopping, the creation procedure of the shopping cart based on the selection and registration of items is complex. When the number of items to be purchased or the number of kinds of options increases, it takes more time to carry out the procedure, which is inefficient.

In an attempt to overcome this difficulty, a technique of creating a shopping cart is developed as follows. A list of items that a customer purchased in the past is stored in advance. This list of items is presented to the customer when the customer purchases items next time thereby to make the customer select items that the customer wishes again. The selected items are registered into a shopping cart, thereby to create the shopping cart (for example, see Japanese Patent Application Laid-open Publication No. 2002-41881).

Even when this conventional technique is used, however, the customer needs to select and register the items once at the beginning. Further, as only the list of items that the customer purchased in the past is presented, when the customer wishes to purchase different items, the customer needs to select and register the items by him/herself.

Therefore, when the customer purchases items on the online shopping Web site that the customer visits for the first time, it takes time to search for desired items from among various kinds of items. Particularly, when the customer is not familiar with the browsing operation on the Web site, the registration work becomes difficult.

When the customer does not have sufficient knowledge about the items to purchase, the item registration work also becomes difficult. For example, when the customer wishes to purchase a personal computer and a printer, the customer needs to have knowledge about whether the printer works with this personal computer. Further, in order to connect the printer with the personal computer, the customer needs to purchase a dedicated cable as well.

In addition, when the account of each part of the personal computer can be selected, the customer needs to select a video card of the personal computer to match the resolution with that of a display unit, and select a random access memory (hereinafter, “RAM”) of a necessary capacity according to the software to be used. Unless the customer has sufficient knowledge about the items, the selection of the items becomes difficult, and shopping cannot be achieved efficiently.

### SUMMARY OF THE INVENTION

It is an object of the present invention to at least solve the problems in the conventional technology.

An apparatus for creating purchase information according to one aspect of the present invention includes a storage unit that storages purchase information concerning items selected by a first person from an item list provided by an online shopping service; a searching unit that searches the storage unit for the purchase information corresponding to a search condition received from a second person; and a creation unit that creates purchase information concerning an item to be purchased by the second person, based on the purchase information searched.

A method of creating purchase information according to another aspect of the present invention includes storing purchase information concerning items selected by a first person from an item list provided by an online shopping service, in a storage unit; receiving a search condition from a second person; searching the storage unit for the purchase information corresponding to the search condition; and creating purchase information concerning an item to be purchased by the second person, based on the purchase information searched.

The computer program product according to another still aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is an explanatory diagram of the concept of a shopping cart creation processing by a shopping cart creation apparatus according to a first embodiment of the present invention;

FIG. 2 is an exemplification of a shopping cart in which items are registered;

FIG. 3 is a functional block diagram of a functional configuration of the shopping cart creation apparatus according to the first embodiment;

FIG. 4 is an exemplification of an account information record in an account information database according to the first embodiment;

FIG. 5 is a flowchart of a processing procedure of the shopping cart creation processing by the shopping cart creation apparatus according to the first embodiment;

FIG. 6 is an exemplification of an account ID input screen according to the first embodiment;

FIG. 7 is an exemplification of a display screen of account information in a re-created shopping cart according to the first embodiment;

FIG. 8 is an explanatory diagram of the concept of a shopping cart creation processing by a shopping cart creation apparatus according to a second embodiment of the present invention;

FIG. 9 is an exemplification of a display screen of account information in a re-created shopping cart according to the second embodiment of the present invention;

FIG. 10 is an explanatory diagram of the concept of a shopping cart creation processing by a shopping cart creation apparatus according to a third embodiment of the present invention;

FIG. 11 is an exemplification of a display screen of account information in a re-created shopping cart according to the third embodiment;

FIG. 12 is a system configuration diagram of a computer system according to a fourth embodiment of the present invention; and

FIG. 13 is a block diagram of the configuration of a main section of the computer system shown in FIG. 12.

### DETAILED DESCRIPTION

Exemplary embodiments of the management information creation apparatus, the management information creation method and the method that makes a computer execute the method according to the present invention will be explained in detail with reference to the accompanying drawings. The purchased item management information that is temporarily created at the time of purchasing an item on the online shopping is called a shopping cart. The apparatus, the method, and the program for making a computer execute the method will be explained as the embodiments. In the following explanation, a customer purchases an item by utilizing account information of a shopping cart that is created by a third person other than the customer.

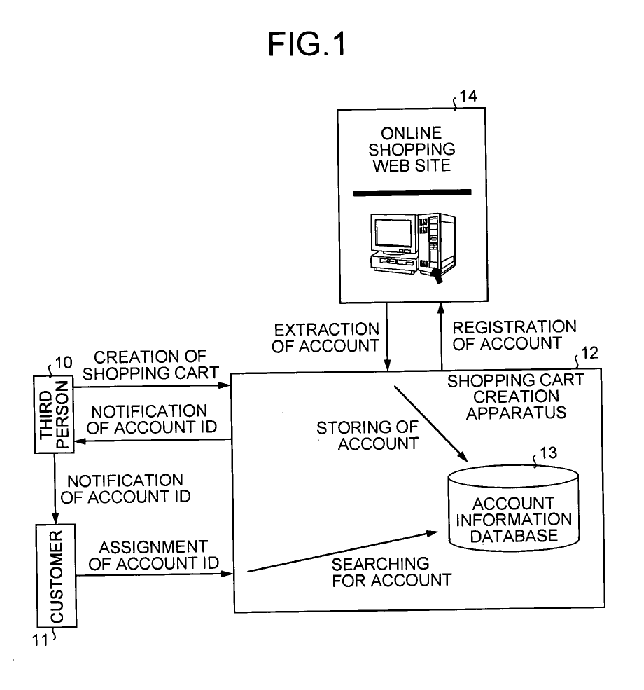

The concept of a shopping cart creation processing that a shopping cart creation apparatus according to a first embodiment carries out will be explained. FIG. 1 is an explanatory diagram of the concept of the shopping cart creation processing by the shopping cart creation apparatus according to the first embodiment.

As shown in FIG. 1, a third person 10 other than an item customer 11 accesses an online shopping Web site 14 that provides online shopping service, via a shopping cart creation apparatus 12, and creates a shopping cart on behalf of the customer 11. The shopping cart creation apparatus 12 extracts account information of the shopping cart created by the third person 10, and stores this information into an account information database 13.

The third person 10 refers to a person who is familiar with the browsing operation on the online shopping Web site 14 and has sufficient knowledge about items sold on this Web site (such as a support staff of the Web site, for example). The third person 10 creates accounting information of the shopping cart on behalf of the customer 11 who is not familiar with the browsing operation and has no knowledge about the items.

The shopping cart creation apparatus 12 creates an account ID that uniquely identifies the account information of the shopping cart, and notifies the third person 10 of this account ID. The account ID is allocated one by one to the account information of each shopping cart, and is stored into the account information database 13 together with the account information.

In order to prevent the account ID from being leaked out to other persons and the shopping cart account information from being altered, the right of access to the shopping cart account information can be authenticated when a password input by the third person 10 is stored into the account information database 13.

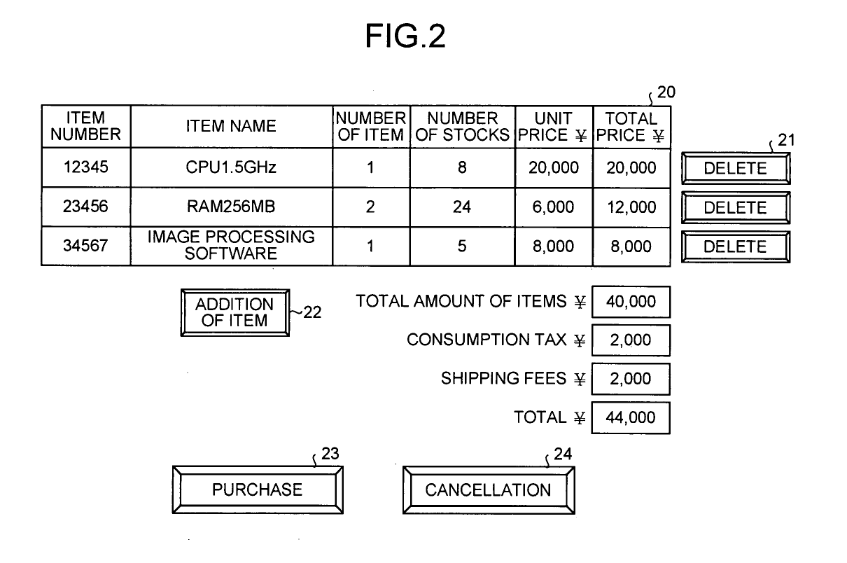

FIG. 2 is an exemplification of a shopping cart in which items are registered. As shown in FIG. 2, in general, the shopping cart has a display of an item account 20 of registered items, a deletion button 21 that is pressed to delete a certain item in the item account, an item addition button 22 that is pressed to add an item, a purchase button 22 that is pressed to purchase an item by settling the item registered in the shopping cart, and a cancellation button 24 that is pressed to cancel the purchase of a registered item.

Referring back to FIG. 1, the third person 10 obtains the account ID, and notifies the customer 11 of the account ID using a communication means such as an electronic mail. The customer 11 receives the notification, and transmits this account ID to the shopping cart creation apparatus 12. With this arrangement, the customer 11 can search the account information database 13 for account information of the shopping cart corresponding to the account ID. The customer 11 can register the shopping cart account information into a shopping cart for the customer 11 on the online shopping Web site 14, and creates the shopping cart.

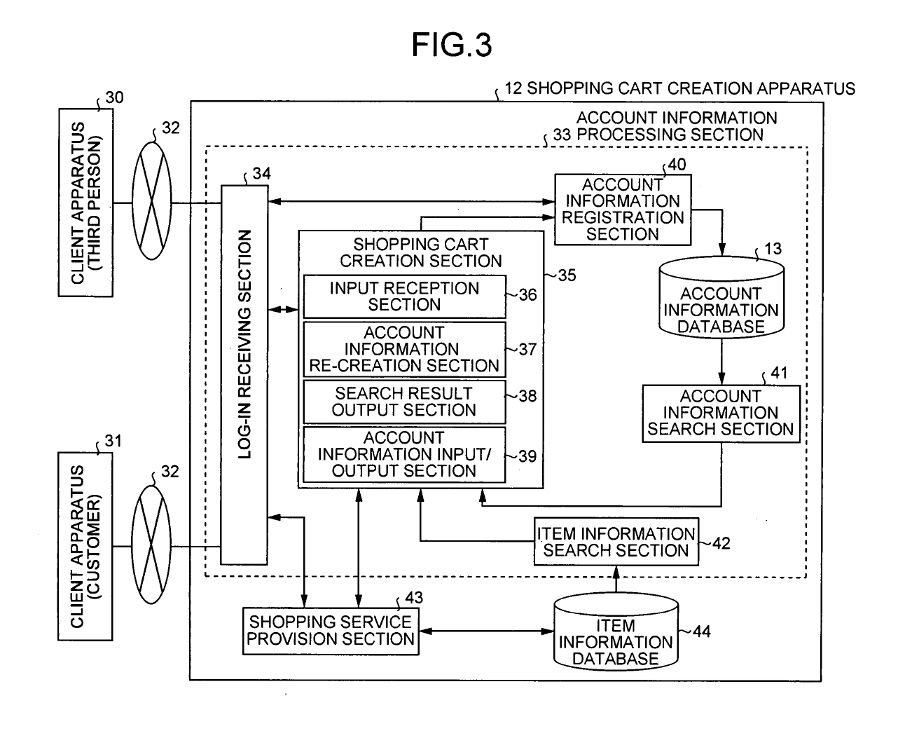

A functional configuration of the shopping cart creation apparatus according to the first embodiment will be explained next. FIG. 3 is a functional block diagram of a functional configuration of the shopping cart creation apparatus according to the first embodiment. As shown in FIG. 3, the shopping cart creation apparatus 12 is connected to a third client apparatus 30 and a customer client apparatus via a network 32. The network 32 includes a local area network (hereinafter, “LAN”), a wide area network (hereinafter, “WAN”), and the Internet.

The shopping cart creation apparatus 12 stores the account information of the shopping cart that the third person 10 creates by operating the third client apparatus 30 connected to the network 32. The shopping cart creation apparatus 12 notifies the third person 10 of the account information by issuing an account ID of the account information. The shopping cart creation apparatus 12 obtains the account ID that the customer 11 inputs by operating the customer client apparatus 31. The shopping cart creation apparatus 12 searches for the account information that is identified by the account ID, and registers the obtained account information into the shopping cart.

The shopping cart creation apparatus 12 includes an account information processing section 33, a shopping service provision section 43, and an item information database 44. The shopping service provision section 43 provides the online shopping service using the shopping cart. The item information database 44 stores item names, prices, and stock status. The account information processing section 33 stores the account information of the shopping cart created by the third person 10, searches for the account information of the shopping cart according to the request from the customer 11, and registers this account information into the shopping cart.

The account information processing section 33 includes a log-in reception section 34, a shopping cart creation section 35, an account information registration section 40, the account information database 13, an account information search section 41, and an item information search section 42. The shopping cart creation section 35 includes an input reception section 36, an account information re-creation section 37, a search result output section 38, and an account information input/output section 39.

The log-in reception section 34 receives a log-in from the third person 10 or the customer 11 to the shopping cart creation apparatus 12. A log-in ID that the third person 10 or the customer 11 has in order to access the shopping cart creation apparatus 12 is used for the log-in.

When the online shopping service that the shopping service provision section 43 provides requests for the log-in ID, the log-in reception section 34 further receives a log-in ID of the online shopping service from the third person 10 or the customer 11. The log-in reception section 34 outputs this log-in ID to the shopping service provision section 43, and logs in the online shopping service.

The shopping service provision section 43 provides a function of the shopping cart to enable the third person 10 to create a shopping cart. In this case, the shopping service provision section 43 obtains item prices and stock status from the item information database 44, and further updates the account information of the shopping cart.

The account information input/output section 39 of the shopping cart creation section 35 obtains the account information of the shopping cart created by the third person from the shopping service provision section 43, and outputs this account information to the account information registration section 40. This account information can be extracted from an HTML document to display the account information of the shopping cart output from the shopping service provision section 43. The account information registration section 40 receives the output account information, and stores this account information into the account information database 13.

The account information registration section 40 generates the account ID of the account information, stores this account ID into the account information database 13, and also outputs the account ID to the third client apparatus 30 via the log-in reception section 34. When a password that authenticates the right of access to the account information is used, the account information registration section 40 stores the password input by the third person 10 as well as the account ID into the account information database 13.

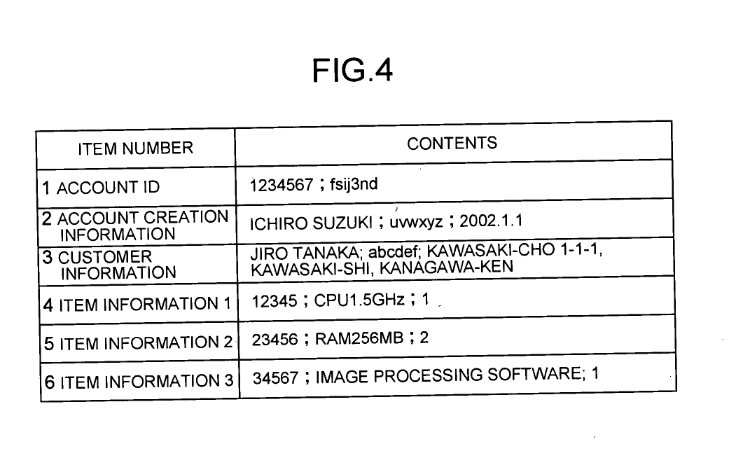

The configuration of the account information record in the account information database 13 will be explained. FIG. 4 is an exemplification of an account information record in an account information database according to the first embodiment. As shown in FIG. 4, the account information record includes an account ID field (item number 1), an account creation information field (item number 2), a customer information field (item number 3), and item information fields (item number 4 to item number 6). The number of the item information fields increases or decreases depending on the number of registered items.

The account ID field (item number 1) stores an account ID and a password in the form like “1234567, fsij3nd”, respectively. The account creation information field (item number 2) stores the name of the third person who created the account, the ID of this person, and the ID created date in the form of like “Ichiro Suzuki, uvwxyz, 2002.1.1”, respectively. The customer information field (item number 3) stores the name of the customer, the customer ID, and the delivery address in the form like “Jiro Tanaka, abcdef, Kawasaki-cho 1-1-1, Kawasaki-shi, Kanagawa-ken”, respectively. The item information fields (item number 4 to item number 6) store the item numbers, item names, and numbers of the items included in the account information created by the third person 10 in the form like “12345, CPU 1.5 gigahertz, 1”, respectively.

Referring back to FIG. 3, the input reception section 36 of the shopping cart creation section 35 receives the account ID that the customer 11 inputs to search for the account information of the shopping cart by operating the customer client apparatus 31. The input reception section 36 request the account information search section 41 to search the account information database 13 for the account information corresponding to this account ID. The account information search section 41 receives this request, and searches for the account information corresponding to this account ID that is input by the customer 11.

The retrieved account information is transmitted to the account information re-creation section 37 of the shopping cart creation section 35. The item information search section 42 searches the item information database 44 for the information including the price and the number of stocks of the item included in the searched account information. The account information search section 37 re-creates the account information created by the third person by using the information retrieved from the account information database 13 and the item information database 44. The search result output section 38 outputs the re-created account information to the customer client apparatus 31.

The input reception section 36 receives from the customer 11 the request for registering the output account information into the shopping cart. The account information input/output section 39 outputs this account information to the shopping service provision section 43, and registers this account information into the shopping cart. After the registration, the shopping service provision section 43 receives from the customer 11 a request for deleting an item included in the account information or an addition of an item not included in the account information. After all the items that the customer wishes to purchase are registered into the shopping cart, the shopping service provision section 43 receives a customer settlement request from the customer 11, and makes settlement of the items.

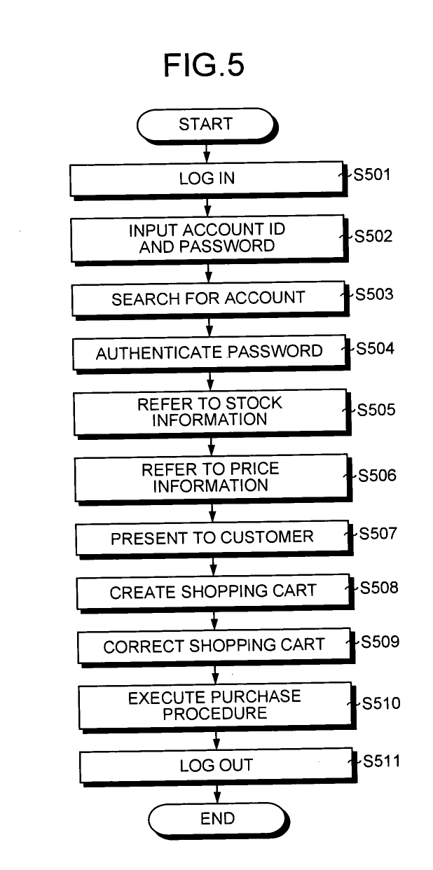

A processing procedure of the shopping cart creation processing by the shopping cart creation apparatus according to the first embodiment will be explained. FIG. 5 is a flowchart of the processing procedure of the shopping cart creation processing by the shopping cart creation apparatus according to the first embodiment.

It is assumed that the account information of the shopping cart created by the third person 10 and the account ID to uniquely identify the account information are already stored in the account information database. It is also assumed that the log-in ID to log in the online shopping service is not necessary.

As shown in FIG. 5, the shopping cart creation apparatus 12 first receives the log-in from the customer 11 (step S501). The reception section 36 receives the input of the account ID and the password of the account information of the shopping cart created by the third person 10 (step S502). The account information search section 41 searches for the account information corresponding to the account ID (step S503).

The input reception section 36 compares the password input by the customer 11 with the password stored in the retrieved account information, thereby to authenticate the password (step S504). When the input password is different from the stored password, the input reception section 36 prompts the customer 11 to input the password again.

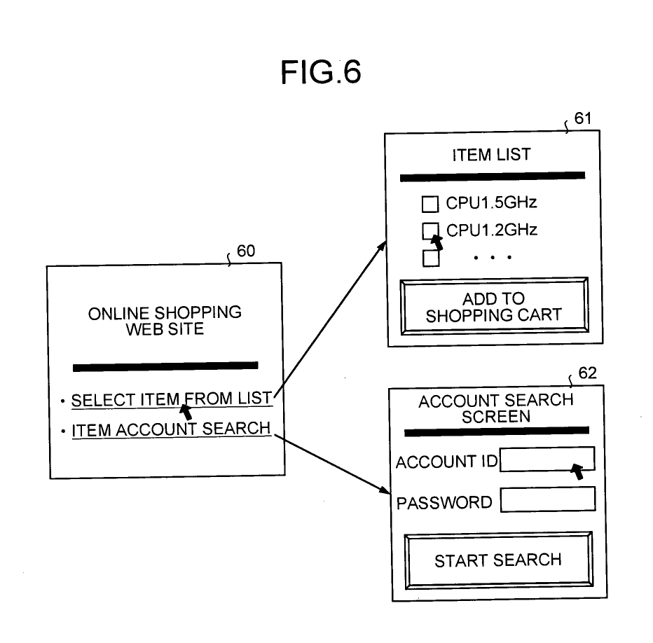

An account ID input screen according to the first embodiment will be explained. FIG. 6 is an exemplification of the account ID input screen according to the first embodiment. As shown in FIG. 6, when the customer 11 logs in the shopping cart creation apparatus, an online shopping Web site initial screen 60 provided by the shopping service provision section 43 is displayed on the customer client apparatus 31.

On the online shopping Web site initial screen 60, the online shopping Web site has a hypertext of selecting a general function of “Select an item from the list”, and a hypertext of selecting a function of “Item account search” to search for account information created by the third person.

When the hypertext of “Select an item from the list” is selected, an item list screen 61 linked to this hypertext is displayed to make it possible to select an item. When an “Add to shopping cart” button is clicked after the selection of the item, the selected item can be registered into the shopping cart. The third person 10 logs in the shopping cart creation apparatus 12, selects the hypertext of “Select an item from the list”, and creates the shopping cart on behalf of the customer 11.

The account information input/output section 39 embeds the hypertext of “Item account search” into the original online shopping Web site initial screen 60. When the customer 11 selects this hypertext, an account search screen 62 linked to this hypertext is displayed to make it possible to input an account ID and a password. When a “Start search” button is clicked, the account information search section 41 searches for account information corresponding to the input account ID (step S503). Then, the password is authenticated (step S504).

Referring back to FIG. 5, when the password input by the customer 11 at step S502 is authenticated (step S504), the item information search section 42 refers to the item stock information included in the account information from the item information database 44 (step S505), and further refers to the item price information (step S506).

The account information re-creation section 37 re-creates the account information of the shopping cart created by the third person 10, based on the retrieved account information and the item stock information and price information that are referred to. The search result output section 38 outputs the re-created account information to the customer client apparatus 31 to present the account information to the customer 11 (step S507).

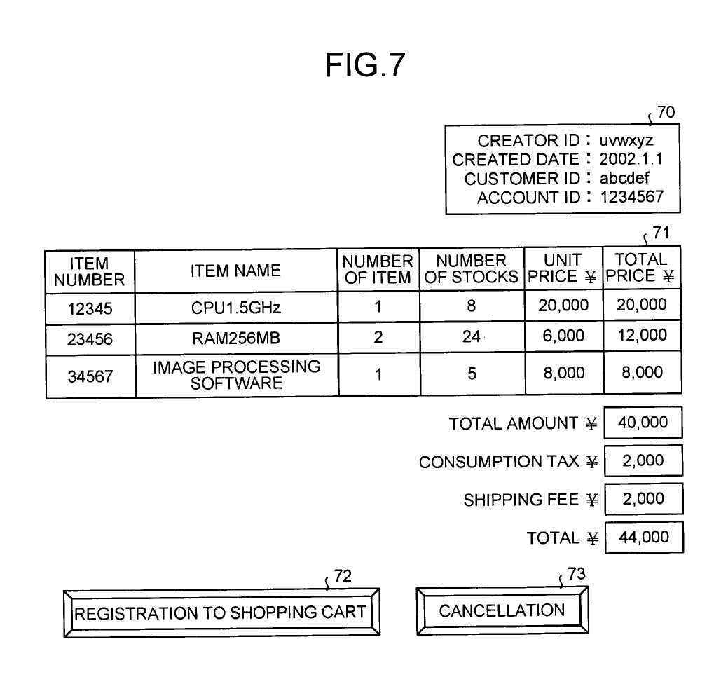

FIG. 7 is an exemplification of a display screen of the account information in a re-created shopping cart according to the first embodiment. As shown in FIG. 7, this display screen has an account ID/account creation information/customer information display section 70, an item account information display section 71, a shopping cart registration button 72, and a registration cancellation button 73.

The account ID/account creation information/customer information display section 70 displays the information including the account ID that is used as a search condition. The item account information display section 71 displays item numbers, item names, and numbers, of the items to be purchased respectively, and numbers of stocks and unit prices retrieved from the item information database 44. Consumption taxes, shipping fees, and total amount calculated by the account information re-creation section 37 are also displayed. The shopping cart registration button 72 is used for the customer 11 to register the re-created account information into the shopping cart. The registration cancellation button 73 is used for the customer 11 to stop the registration of the account information.

Referring back to FIG. 5, after the processing at step S507, the input section 36 receives a request from the customer 11 to register the account information into the shopping cart. The account information input/output section 39 outputs the account information to the shopping service provision section 43, registers the account information into the shopping cart, and creates the shopping cart (step S508).

The shopping service provision section 43 has a function of deleting an item registered in the shopping cart, and a function of adding a new item to the shopping cart. The shopping service provision section 43 receives from the customer 11 a correction of the shopping cart by utilizing these functions (step S509). After the correction, the shopping service provision section 43 receives a purchase procedure execution request from the customer 11, and executes the purchase procedure such as the item settlement processing (step S510). After ending the customer procedure, the shopping service provision section 43 logs out the customer 11 (step S511), and ends the shopping cart creation processing.

As described above, according to the first embodiment, the shopping cart creation apparatus 12 is configured as follows. The third person 10 creates the account information of the shopping cart on behalf of the customer 11 who is not familiar with the browsing operation on the online shopping Web site 14 and has no knowledge about the items. The shopping cart creation apparatus 12 stores the account information of the shopping cart, the account ID that uniquely identifies the account information of the shopping cart into the account information database 13. The account information search section 41 searches the account information database 13 for the account information created by the third person using the account ID input by the customer 11 as a search condition. The account information search section 41 registers this account information into the shopping cart of the customer 11, and creates the shopping cart of the customer 11. Therefore, the customer 11 can easily search for the account information created by the third person who is familiar with the browsing operation and has item knowledge by using the account ID. The customer 11 can create the shopping cart using the account information, and efficiently carry out the online shopping.

In the first embodiment, the account ID is allocated to the account information of the shopping cart. The account information is searched for using the account ID as the search condition. The retrieved account information is registered into the shopping cart, thereby to create the shopping cart. However, the search condition is not limited to the account ID. The present invention can also be applied to a case of using other item as a search condition.

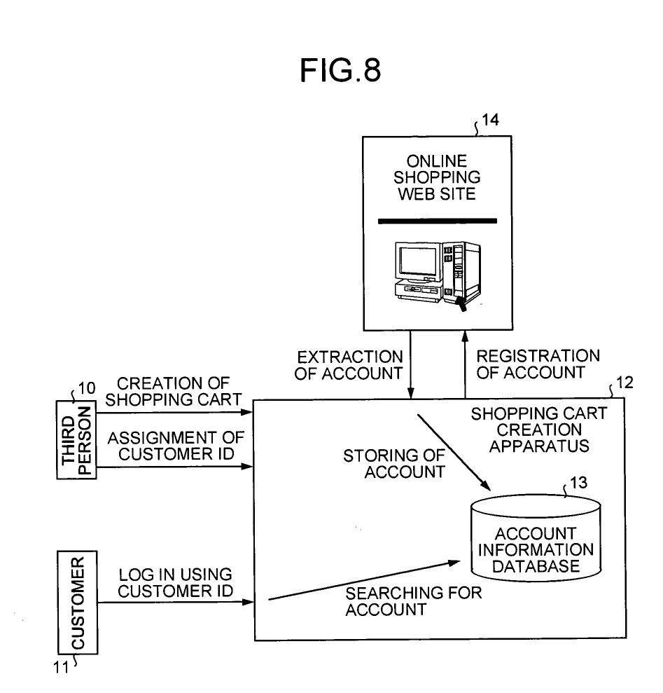

In a second embodiment, a case of using the customer ID that uniquely identifies the customer as the search condition for the account information of the shopping cart will be explained. First, the concept of a shopping cart creation processing by a shopping cart creation apparatus according to the second embodiment of the present invention will be explained. FIG. 8 is an explanatory diagram of the concept of the shopping cart creation processing by the shopping cart creation apparatus according to the second embodiment.

As shown in FIG. 8, the third person 10 other than the item customer 11 accesses the online shopping Web site 14 that provides online shopping service, via the shopping cart creation apparatus 12, and creates a shopping cart on behalf of the customer 11. The shopping cart creation apparatus 12 extracts account information of the shopping cart created by the third person 10, and stores this information into the account information database 13

The third person 10 refers to a person who is familiar with the browsing operation on the online shopping Web site 14 and has sufficient knowledge about items sold on this Web site, like in the first embodiment. In a purchasing system within an enterprise, an employee who desires the purchasing of an item can create a shopping cart. A purchasing division that is actually responsible for the purchasing of an item can reproduce the shopping cart, and examine and purchase the item. In this case, the third person 10 and the customer 11 are the employee and the purchasing division, respectively. With this arrangement, the employee can securely transmit the details of the item that the employee desires to the purchasing division.

The shopping cart creation apparatus 12 stores the customer ID assigned from the third person 10, as well as the account information of the shopping cart. The customer ID may be the one that can uniquely discriminate between the customer 11 and other persons. In this example, a case of employing the log-in ID that is used for the customer 11 to log in the shopping cart creation apparatus 12 as the customer ID will be explained.

The configuration of the account information record that is stored into the account information database 13 is similar to that according to the first embodiment shown in FIG. 4. The account information record may include at least the customer ID and the item information. As shown in FIG. 4, the item information and the customer ID “abcdef” are stored into the customer information field (item number 3).

When the customer 11 logs in the shopping cart creation apparatus 12 using the log-in ID, the shopping cart creation apparatus 12 searches the account information database 13 for the account information of the shopping cart corresponding to this log-in ID. Pieces of account information may correspond to the log-in ID of the customer 11. In this case, the pieces of account information are retrieved. Out of the retrieved pieces of account information, the shopping cart creation apparatus 12 registers the account information selected by the customer 11 into the shopping cart for the customer 11 on the online shopping Web site 14, and creates the shopping cart.

A functional configuration of the shopping cart creation apparatus according to the second embodiment will be explained. In the second embodiment, the functions of the log-in reception section 34, the input reception section 36, the account information re-creation section 37, the search result output section 38, the account information input/output section 39, and the account information search section 41 are different from the functions of these sections according to the first embodiment. Other functional configurations are similar to those according to the first embodiment shown in FIG. 3. Therefore, these corresponding sections are assigned with like reference numerals, and only the different sections will be explained.

According to the second embodiment, the log-in reception section 34 receives a log-in to the shopping cart creation apparatus from the third person 10 or the customer 11. After the log-in processing for the customer 11 ends, the log-in reception section 34 transmits the log-in ID of the customer 11 to the input reception section 36. The input reception section 36 receives the log-in ID of the customer 11, and requests the account information search section 41 to search the account information database 13 for the account information corresponding to the log-in ID.

The account information search section 41 receives this request, and searches for the account information corresponding to the log-in ID of the customer 11. The account information search section 41 transmits the retrieved account information to the account information re-creation section 37 of the shopping cart creation section 35. The item information search section 42 searches the item information database 44 for the information including item prices and number of stocks of the items included in the retrieved account information.

The account information re-creation section 37 re-creates the account information created by the third person 10 by using the information retrieved from the account information database 13 and the item information database 44. The search result output section 38 outputs the re-created account information to the customer client apparatus 31, and presents this account information to the customer 11. When there are pieces of account information corresponding to the log-in ID of the customer 11, the search result output section 38 outputs the pieces of account information.

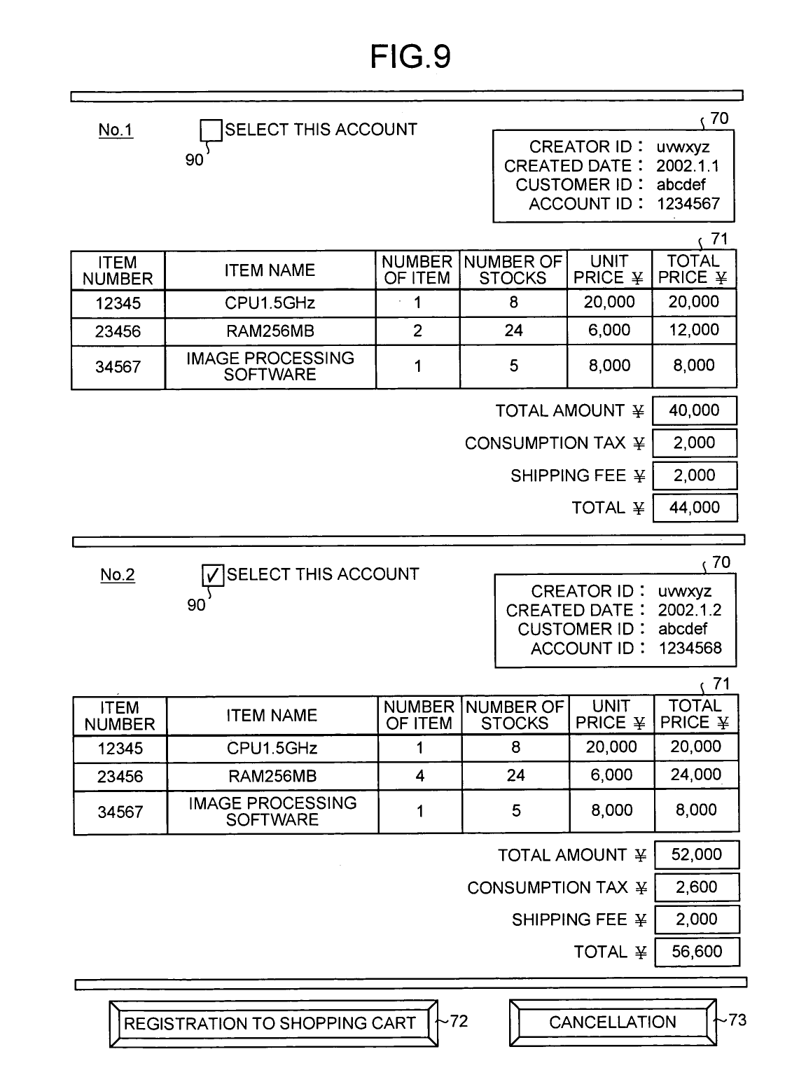

FIG. 9 is an exemplification of a display screen of the account information in the re-created shopping cart according to the second embodiment. As shown in FIG. 9, this display screen includes pieces of account information, the shopping cart registration button 72, and the registration cancellation button 73. The display of the pieces of account information indicates that the pieces of account information corresponding to the log-in ID of the customer 11 are stored in the account information database 13. Each piece of account information includes the account ID/account creation information/customer information display section 70, the item account information display section 71, and a check box 90.

The account ID/account creation information/customer information display section 70 displays the information including the customer ID (that is, the log-in ID) that is used as a search condition. The item account information display section 71 displays item numbers, item names, and numbers, of the items to be purchased, respectively, and numbers of stocks and unit prices retrieved from the item information database 44. Consumption taxes, shipping fees, and total amount calculated by the account information re-creation section 37 are also displayed.

The check box 90 is used for the customer 11 to select a desired piece of account information to be registered into the shopping cart from among the pieces of account information. The shopping cart registration button 72 is used for the customer 11 to instruct the check box 90 to register the checked account information (the account information No. 2, in this case) into the shopping cart. The registration cancellation button 73 is used for the customer 11 to stop the registration of the account information.

Referring back to the explanation about the functional configuration of the shopping cart creation apparatus, when the input reception section 36 receives a request from the customer 11 to register the selected account information into the shopping cart, the account information input/output section 39 outputs the account information to the shopping service provision section 43. The account information input/output section 39 registers the account information into the shopping cart, and creates the shopping cart. The functions of other sections are similar to those of the sections according to the first embodiment shown in FIG. 3, and their explanation will be omitted.

The processing procedure of the shopping cart creation processing that the shopping cart creation apparatus according to the second embodiment carries out will be explained. In the second embodiment, the customer 11 ends the log-in at step S501 according to the first embodiment shown in FIG. 5. Then, the account information search section 41 searches for the account information corresponding to the log-in ID of the customer 11 that is used for the log-in as a search condition. This corresponds to step S503 shown in FIG. 5. In the second embodiment, the “input of the account ID and the password” at step S502 shown in FIG. 5 is excluded.

When a password to authenticate the right of access to the account information is set, the input reception section 36 compares the password input by the customer 11 with the password stored in the retrieved account information, thereby to authenticate the password in a similar manner that at step S504 shown in FIG. 5. When the input password is different from the stored password, the input reception section 36 prompts the customer 11 to input the password again. The subsequent processing is similar to that at step S505 afterward shown in FIG. 5, and their explanation is omitted.

As described above, according to the second embodiment, the log-in ID of the customer 11 is allocated to the account information of the shopping cart. The account information is searched for using this log-in ID as the search condition. The retrieved account information is registered into the shopping cart, thereby to create the shopping cart. Therefore, the customer 11 can easily search for the account information created by the third person who is familiar with the browsing operation and has item knowledge, by using the log-in ID. Accordingly, the shopping cart by utilizing this account information can be created, and the online shopping can be efficiently carried out.

In the second embodiment, the customer ID is the search condition for the account information of the shopping cart. However, the search condition may be a creator ID that uniquely identifies the third person 10 who creates the account information. In this case, the shopping cart creation apparatus 12 searches for the account information corresponding to the creator ID that is input by the customer 11, registers the account information into the shopping cart, and creates the shopping cart of the customer 11.

The shopping cart creation apparatus 12 according to this modification is different from the shopping cart creation apparatuses 12 according to the first and second embodiments only in that the creator ID is the search condition for the input account information. Therefore, this shopping cart creation apparatus 12 can be easily achieved based on the description in the first and second embodiments. The customer can easily search for the account information created by the third person who is familiar with the browsing operation and has item knowledge, by using the creator ID. Accordingly, the shopping cart by utilizing this account information can be created, and the online shopping can be efficiently carried out.

In the first and second embodiments, the account ID, the customer ID, or the creator ID are allocated to the account information of the shopping cart respectively. The account information is searched for using the account ID, the customer ID, or the creator ID as the search condition. The retrieved account information is registered into the shopping cart, thereby to create the shopping cart. However, the search condition is not limited to the above IDs. The present invention can also be applied to a case of using an item name as a search condition.

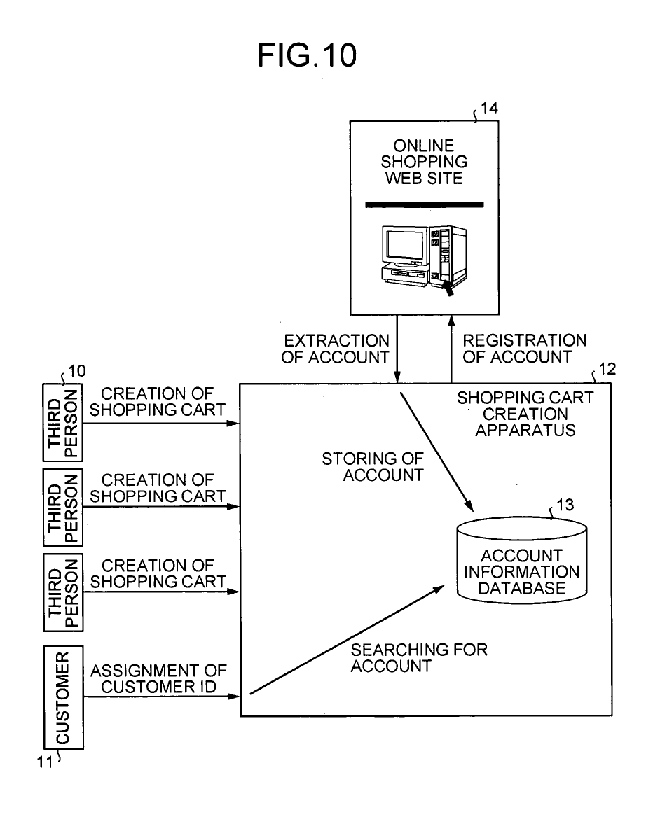

In a third embodiment, a case of using the item ID as the search condition for the account information of the shopping cart will be explained. First, the concept of a shopping cart creation processing by a shopping cart creation apparatus according to the third embodiment of the present invention will be explained. FIG. 10 is an explanatory diagram of the concept of the shopping cart creation processing by the shopping cart creation apparatus according to the third embodiment.

As shown in FIG. 10, the third person 10 accesses the online shopping Web site 14 via the shopping cart creation apparatus 12, extracts the account information of the shopping cart created at the time of purchasing an item, and stores the account information into the account information database 13. The third person 10 may be a general public having no concern with the customer 11.

The configuration of the account information record that is stored into the account information database 13 is similar to that according to the first embodiment shown in FIG. 4, and the account information record may contain at least item information. As shown in FIG. 4, the item numbers, item names, and numbers of the items “12345, CPU 1.5 gigahertz; 1” respectively are stored into the item information fields (item number 4 to item number 6).

When the customer 11 inputs the name of one desired item through the operation of the customer client apparatus 31, the account information that includes this item as the item information is searched for. As a result of the searching for the one item name, pieces of account information may be naturally searched for. In this case, the account information that the customer 11 selects out of the pieces of account information is registered into the shopping cart for the customer 11 on the online shopping Web site 14, thereby to create the shopping cart.

A functional configuration of the shopping cart creation apparatus according to the third embodiment will be explained next. In the third embodiment, the functions of the input reception section 36, the account information re-creation section 37, the search result output section 38, the account information input/output section 39, and the account information search section 41 are different from the functions of these sections according to the first embodiment. Other functional configurations are similar to those according to the first embodiment shown in FIG. 3. Therefore, these corresponding sections are assigned with like reference numerals, and only the different sections will be explained.

In the third embodiment, the input reception section 36 receives the item name that the customer 11 inputs to search for the account information of the shopping cart by operating the customer client apparatus 31. The input reception section 36 requests the account information search section 41 to search the account information database 13 for the account information that includes this item name. The account information search section 41 receives this request, and searches for the account information that includes the item name that the customer 11 inputs. The item information search section 42 searches the item information database 44 for the information including item prices and number of stocks of the items included in the retrieved account information.

The account information re-creation section 37 re-creates the account information created by the third person 10 by using the information retrieved from the account information database 13 and the item information database 44. The search result output section 38 outputs the re-created account information to the customer client apparatus 31, and presents this account information to the customer 11. When there are pieces of account information including the item name assigned by the customer 11, the pieces of account information are output.

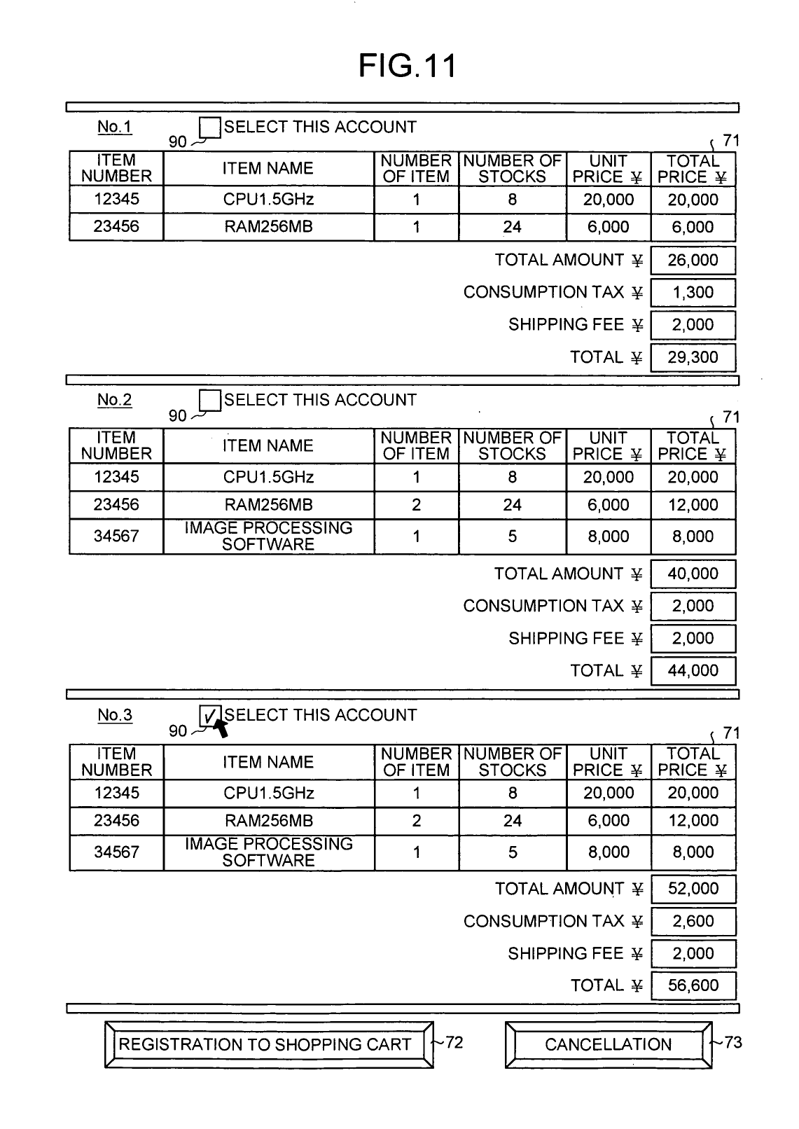

FIG. 11 is an exemplification of a display screen of the account information in the re-created shopping cart according to the third embodiment. As shown in FIG. 11, this display screen includes pieces of account information, the shopping cart registration button 72, and the registration cancellation button 73. The display of the pieces of account information indicates that the pieces of account information including the item name (the CPU 1.5 gigahertz in this case) that the customer assigns are stored in the account information database 13. Each piece of account information includes the item account information display section 71, and the check box 90.

The item account information display section 71 displays item numbers, item names, and numbers, of the items to be purchased respectively, and numbers of stocks and unit prices retrieved from the item information database 44. Consumption taxes, shipping fees, and total amount calculated by the account information re-creation section 37 are also displayed.

The check box 90 is used for the customer 11 to select a desired piece of account information to be registered into the shopping cart from among the pieces of account information. The shopping cart registration button 72 is used for the customer 11 to instruct the check box 90 to register the checked account information (the account information No. 3, in this case) into the shopping cart. The registration cancellation button 73 is used for the customer 11 to stop the registration of the account information.

Referring back to the explanation about the functional configuration of the shopping cart creation apparatus, when the input reception section 36 receives a request from the customer 11 to register the selected account information into the shopping cart, the account information input/output section 39 outputs the account information to the shopping service provision section 43. The account information input/output section 39 registers the account information into the shopping cart, and creates the shopping cart. The functions of other sections are similar to those of the sections according to the first embodiment shown in FIG. 3, and their explanation will be omitted.

The processing procedure of the shopping cart creation processing that the shopping cart creation apparatus according to the third embodiment carries out will be explained. In the third embodiment, an item name is input in place of the account ID and the password at step S502 according to the first embodiment shown in FIG. 5.

The account information including the item name is searched for using the item name as the search condition. This processing corresponds to that at step S503 shown in FIG. 5. In the third embodiment, the “password authentication” at step S504 shown in FIG. 5 is excluded. The subsequent processing is similar to that at step S505 afterward shown in FIG. 5, and therefore, the explanation thereof will be omitted.

As described above, according to the third embodiment, the account information that the third person 10 as general public creates is stored into the account information database 13. The account information including the item name is searched for using the item name of the item that the customer 11 desires to purchase as the search condition. The retrieved account information is registered into the shopping cart, thereby to create the shopping cart. Therefore, the customer 11 can easily search for the item to be purchased, by using the item name in the account information that the third person 10 who purchased the item in the past creates. The customer 11 can create the shopping cart by utilizing this item name, and can efficiently carry out the online shopping.

A personal computer or a computer system such as a workstation can realize the shopping cart creation apparatus (i.e., the management information creation apparatus) and the method of creating a shopping cart (i.e., the management information creation method) explained in the first, second and third embodiments, by executing a program created in advance. In the fourth embodiment, the computer system will be explained that executes a shopping cart creation program (i.e., a management information creation program) that has functions similar to those of the shopping cart creation program (i.e., the shopping cart creation program) explained in the first, second and third embodiments.

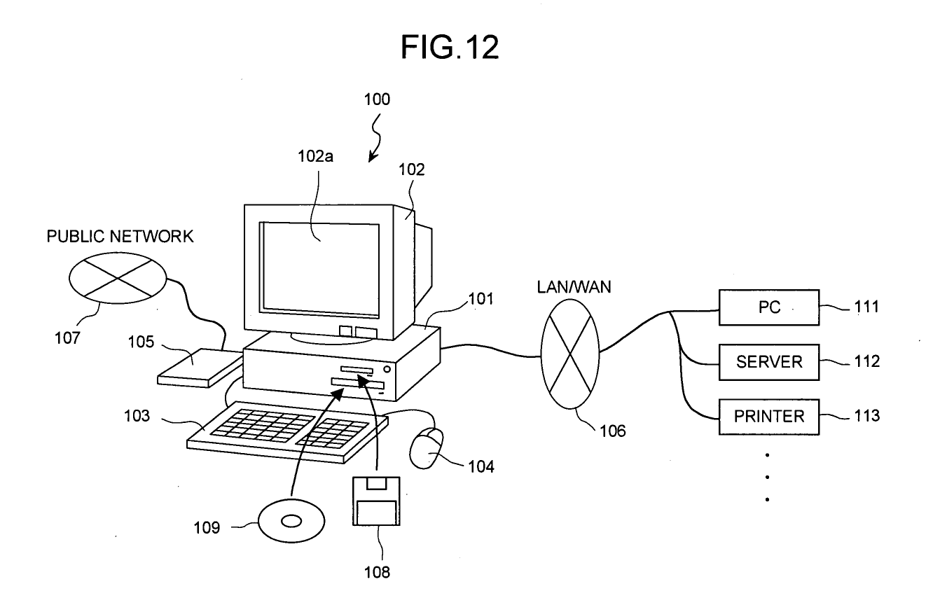

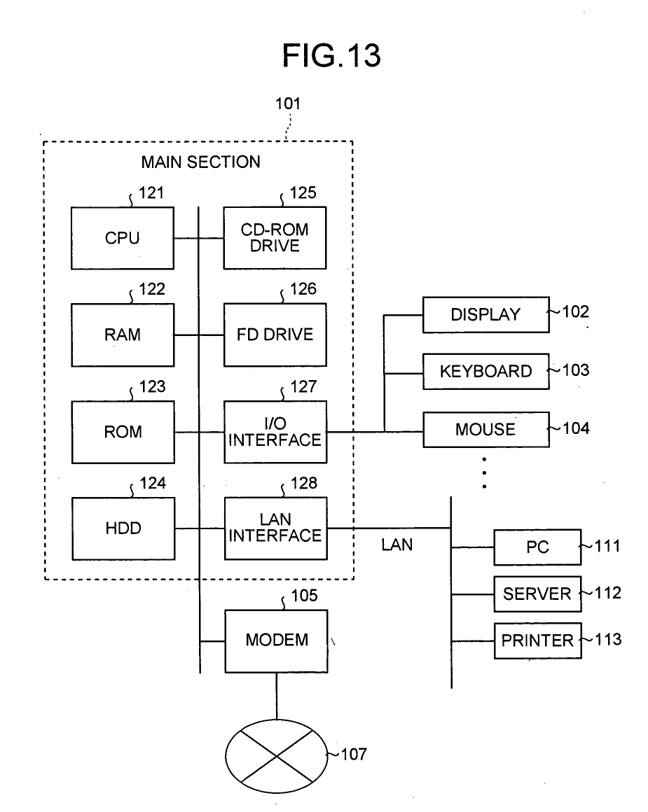

FIG. 12 is a system configuration diagram of the computer system according to a fourth embodiment of the present invention, and FIG. 13 is a block diagram of the configuration of a main section of the computer system shown in FIG. 12. As shown in FIG. 12, a computer system 100 according to the fourth embodiment comprises a main section 101, a display 102 that displays information such as an image on a display screen 102a according to an instruction from the main section 101, a keyboard 103 that is used to input various kinds of information to the computer system 100, and a mouse 104 that is used to assign an optional position on the display screen 102a of the display 102.

As shown in FIG. 13, the main section 101 of the computer system 100 comprises a CPU 121, a RAM 122, a read only memory (hereinafter, “ROM”) 123, a hard disk drive (hereinafter, “HDD”) 124, a CD-ROM drive 125 that receives the CD-ROM 109, a flexible disk (hereinafter, “FD”) drive 126 that receives an FD 108, an I/O interface 127 that connects the display 102, the keyboard 103, and the mouse 104 to the main section, and a LAN interface 128 that is connected to a LAN/WAN 106.

The computer system 100 is connected with a modem 105 that connects the computer system to a public network 107 such as the Internet. The computer system 100 is further connected with other computer system (PC) 111, a server 112, and a printer 113 via the LAN interface 128 and the LAN/WAN 106.

The computer system 100 reads and executes a shopping cart creation program that is recorded on a predetermined recording medium, thereby to realize the shopping cart creation apparatus (and the shopping cart creation method). The predetermined recording medium includes all recording media that record a shopping cart creation program that can be read by the computer system 100. In other words, the recording medium includes “portable physical media” such as the FD 108, the CD-ROM 109, an magnet optical (MO) disk, a digital versatile disk (DVD), an optical magnetic disk, and an IC card, “fixed physical media” such as the HDD 124, the RAM 122, and the ROM 123 that are provided inside and outside the computer system 100, and “communication media” that hold a program during a short time in transmitting the program such as the public network 107 that is connected via the modem 105, and the LAN/WAN 106 that is connected with the other computer system 111 and the server 112.

The shopping cart creation program is a computer-readable program that is recorded on the recording media such as the “portable physical media”, the “fixed physical media”, and the “communication media”. The computer system 100 reads this shopping cart creation program from these recording media, and executes the program, thereby to realize the shopping cart creation apparatus and method. The computer system 100 is not the only system that executes the shopping cart creation program. The present invention can also be similarly applied to other cases. For example, the other computer system 111 or the server 112 can execute the shopping cart creation program. Alternatively, the other computer system 111 and the server 112 can jointly execute the shopping cart creation program.

Although embodiments of the present invention are described above, variously modified embodiments other than the above-described embodiments may be resorted to without departing from the spirit and scope of the invention as hereinafter defined by the appended claims.

In the present embodiment, the third person 10 accesses the online shopping Web site 14, and extracts account information from the shopping cart that is created by utilizing the function of the online shopping Web site 14. However, the creation of the account information is not limited to the method in the present invention. For example, the third person 10 may directly create the account information in the format shown in FIG. 4, and store this account information into the account information database 13.

In the present embodiment, the customer of an item utilizes the account information of the shopping cart that is created by the third person other than this customer. Alternatively, it is also possible to arrange as follows. The customer searches for the account information of the shopping cart that the customer utilized to purchase an item in the past. Then, the customer registers the retrieved account information of the shopping cart into the shopping cart of the customer, and utilizes this information again.

In the present embodiment, the shopping service provision section 43 and the item information database 44 are within the shopping cart creation apparatus 12. The shopping cart creation apparatus 12 has the Web server function to provide the online shopping Web site 14. Alternatively, it is also possible to arrange as follows. The shopping service provision section 43 and the item information database 44 are within the online shopping service provision server that is connected to the network 32. In this case, the shopping cart creation apparatus 12 and the online shopping service provision server can exchange data concerning the creation of the shopping cart like the account information via the network 32.

The whole or a part of the processing that is explained to be automatically carried out in the present embodiment can also be carried out manually. Further, the whole or a part of the processing that is explained to be manually carried out in the present embodiment can also be carried out automatically according to a known method. Except where specified otherwise, it is possible to optionally change the information including the processing procedures, control procedures, detailed names, various kinds of data and parameters that are shown in the document and drawings.

The configurational elements of each apparatus shown in the drawings are conceptual functions, and they are not always necessary to be physically configured as illustrated in the drawings. In other words, the detailed modes of distribution and integration of each apparatus are not limited to those shown in the drawings. The whole or a part of each apparatus may be functionally or physically distributed and integrated in an optional unit corresponding to various loads and using status. Further, the whole or an optional part of the processing functions that are carried out by each apparatus can be realized by a CPU and a program that is analyzed and executed by the CPU, or as hardware according to a wired logic.

As explained above, according to a first aspect of the present invention, at least information concerning an item is stored as account information of the purchased item management information that is created by at least a third person. The account information of the purchased item management information is received from the customer as a search condition. The account information of the purchased item management information corresponding to the search condition is searched for. The retrieved account information of the purchased item management information is registered into the purchased item management information of the customer, thereby to create the purchased item management information of the customer. With this arrangement, there is an effect that the customer can obtain the management information creation apparatus that utilizes the account information created by at least the third person who is familiar with the creation of the purchased item management information and has knowledge about the item, thereby to create the purchased item management information easily and efficiently, and carry out the online shopping.

According to a second aspect of the present invention, account identification information to uniquely identify the account information of each purchased item management information is stored as account information of the purchased item management information. The account identification information is received from the customer as a search condition. The account information of the purchased item management information corresponding to the search condition is searched for. With this arrangement, there is an effect that the customer can obtain the management information creation apparatus that searches for the account information of the purchased item management information created by at least the third person who is familiar with the creation of the purchased item management information and has knowledge about the item, based on the account identification information, thereby to create the purchased item management information easily and efficiently, and carry out the online shopping.

According to a third aspect of the present invention, customer identification information to uniquely identify a customer who is scheduled to purchase an item included in the account information of each purchased item management information is further stored as account information of the purchased item management information. The customer identification information is received from the customer as a search condition. The account information of the purchased item management information corresponding to the search condition is searched for. With this arrangement, there is an effect that the customer can obtain the management information creation apparatus that searches for the account information of the purchased item management information created by at least the third person who is familiar with the creation of the purchased item management information and has knowledge about the item, based on the customer identification information, thereby to create the purchased item management information easily and efficiently, and carry out the online shopping.

According to a fourth aspect of the present invention, item identification information to uniquely identify an item included in the account information of each purchased item management information is further stored as account information of the purchased item management information. The item identification information is received from the customer as a search condition. The account information of the purchased item management information corresponding to the search condition is searched for. With this arrangement, there is an effect that the customer can obtain the management information creation apparatus that searches for the account information of the purchased item management information created by at least the third person who purchased the item in the past that the customer is scheduled to purchase, based on the item identification information, thereby to create the purchased item management information easily and efficiently, and carry out the online shopping.

According to a fifth aspect of the present invention, creator identification information to uniquely identify the third person who creates the account information of each purchased item management information is further stored as account information of the purchased item management information. The creator identification information is received from the customer as a search condition. The account information of the purchased item management information corresponding to the search condition is searched for. With this arrangement, there is an effect that the customer can obtain the management information creation apparatus that searches for the account information of the purchased item management information created by at least the third person who is familiar with the creation of the purchased item management information and has knowledge about the item, based on the creator identification information, thereby to create the purchased item management information easily and efficiently, and carry out the online shopping.

According to a sixth aspect of the present invention, at least information concerning an item is stored as account information of the purchased item management information that is created by at least a third person. The account information of the purchased item management information is received from the customer as a search condition. The account information of the purchased item management information corresponding to the search condition is searched for. The retrieved account information of the purchased item management information is registered into the purchased item management information of the customer, thereby to create the purchased item management information of the customer. With this arrangement, there is an effect that the customer can obtain the management information creation method of utilizing the account information created by at least the third person who is familiar with the creation of the purchased item management information and has knowledge about the item, thereby to create the purchased item management information easily and efficiently, and carry out the online shopping.

According to a seventh aspect of the present invention, account identification information to uniquely identify the account information of each purchased item management information is stored as account information of the purchased item management information. The account identification information is received from the customer as a search condition. The account information of the purchased item management information corresponding to the search condition is searched for. With this arrangement, there is an effect that the customer can obtain the management information creation method of searching for the account information of the purchased item management information created by at least the third person who is familiar with the creation of the purchased item management information and has knowledge about the item, based on the account identification information, thereby to create the purchased item management information easily and efficiently, and carry out the online shopping.

According to an eighth aspect of the present invention, customer identification information to uniquely identify a customer who is scheduled to purchase an item included in the account information of each purchased item management information is further stored as account information of the purchased item management information. The customer identification information is received from the customer as a search condition. The account information of the purchased item management information corresponding to the search condition is searched for. With this arrangement, there is an effect that the customer can obtain the management information creation method of searching for the account information of the purchased item management information created by at least the third person who is familiar with the creation of the purchased item management information and has knowledge about the item, based on the customer identification information, thereby to create the purchased item management information easily and efficiently, and carry out the online shopping.

According to a ninth aspect of the present invention, item identification information to uniquely identify an item included in the account information of each purchased item management information is further stored as account information of the purchased item management information. The item identification information is received from the customer as a search condition. The account information of the purchased item management information corresponding to the search condition is searched for. With this arrangement, there is an effect that the customer can obtain the management information creation method of searching for the account information of the purchased item management information created by at least the third person who purchased the item in the past that the customer is scheduled to purchase, based on the item identification information, thereby to create the purchased item management information easily and efficiently, and carry out the online shopping.

According to a tenth aspect of the present invention, at least information concerning an item is stored as account information of the purchased item management information that is created by at least a third person. The account information of the purchased item management information is received from the customer as a search condition. The account information of the purchased item management information corresponding to the search condition is searched for. The retrieved account information of the purchased item management information is registered into the purchased item management information of the customer, thereby to create the purchased item management information of the customer. With this arrangement, there is an effect that the customer can obtain the program for utilizing the account information created by at least the third person who is familiar with the creation of the purchased item management information and has knowledge about the item, thereby to create the purchased item management information easily and efficiently, and carry out the online shopping.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for creating purchase information, comprising:
a storage unit that storages purchase information concerning items selected by a first person from an item list provided by an online shopping service;
a searching unit that searches the storage unit for the purchase information corresponding to a search condition received from a second person; and
a creation unit that creates purchase information concerning an item to be purchased by the second person, based on the purchase information searched.

2. The apparatus according to claim 1, wherein
the storage unit further stores purchase identification information to uniquely identify the purchase information, and
the searching unit searches the storage unit for the purchase information corresponding to the purchase identification information, as the search condition, received from the second person.

3. The apparatus according to claim 1, wherein
the storage unit further stores person identification information to uniquely identify the second person, and
the searching unit searches the storage unit for the purchase information corresponding to the person identification information, as the search condition, received from the second person.

4. The apparatus according to claim 3, wherein
the person identification information includes information to identify the second person as a customer who purchases the item.

5. The apparatus according to claim 1, wherein
the storage unit further stores item identification information to uniquely identify the item, and
the searching unit searches the storage unit for the purchase information corresponding to the item identification information, as the search condition, received from the second person.

6. The apparatus according to claim 1, wherein
the storage unit further stores person identification information to uniquely identify the first person, and
the searching unit searches the storage unit for the purchase information corresponding to the person identification information, as the search condition, received from the second person.

7. The apparatus according to claim 6, wherein
the person identification information includes information to identify the first person as a supervisor who manages the online shopping service.

8. A method of creating purchase information, comprising:
storing purchase information concerning items selected by a first person from an item list provided by an online shopping service, in a storage unit;
receiving a search condition from a second person;
searching the storage unit for the purchase information corresponding to the search condition; and
creating purchase information concerning an item to be purchased by the second person, based on the purchase information searched.

9. The method according to claim 8, further comprising
storing purchase identification information to uniquely identify the purchase information, wherein
the receiving includes receiving the purchase identification information, as the search condition, from the second person, and
the searching includes searching the storage unit for the purchase information corresponding to the purchase identification information received.

10. The method according to claim 8, further comprising
storing person identification information to uniquely identify the second person, wherein
the receiving includes receiving the person identification information, as the search condition, from the second person, and the searching includes searching the storage unit for the purchase information corresponding to the person identification information received.

11. The method according to claim 10, wherein
the person identification information includes information to identify the second person as a customer who purchases the item.

12. The method according to claim 8, further comprising
storing item identification information to uniquely identify the item, wherein
the receiving includes receiving the item identification information, as the search condition, from the second person, and
the searching includes searching the storage unit for the purchase information corresponding to the item identification information received.

13. The method according to claim 8, further comprising
storing purchase identification information to uniquely identify the first person, wherein
the receiving includes receiving the person identification information, as the search condition, from the second person, and
the searching includes searching the storage unit for the purchase information corresponding to the person identification information received.

14. The method according to claim 13, wherein
the person identification information includes information to identify the first person as a supervisor who manages the online shopping service.

15. A computer program product including computer executable instructions stored on a computer readable medium, wherein the instructions, when executed by the computer, cause the computer to perform:
storing purchase information concerning items selected by a first person from an item list provided by an online shopping service, in a storage unit;
receiving a search condition from a second person;
searching the storage unit for the purchase information corresponding to the search condition; and
creating purchase information concerning an item to be purchased by the second person, based on the purchase information searched.
